(19) United States
(12) Patent Application Publication
(10) Pub. No.: US 2004/0145816 A1
(43) Pub. Date: Jul. 29, 2004

(54) Microscope lens arrangement

(76) Inventor: Thomas Engel, Erfurt Ortsteil Niedemissa (DE)

Correspondence Address: Douglas J Christensen, Patterson Thuente Skaar & Christensen, 4800 IDS Center, 80 South Eighth Street, Minneapolis, MN, 55402, US

(21) Appl. No.: 10/472,627

(22) PCT Filed: Jul. 19, 2002
(86) PCT No.: PCT/EP02/08100

(30) Foreign Application Priority Data
Jul. 19, 2001 (DE) 101 35 321.9

(51) Int. Cl. G02B 21/02

(52) U.S. Cl. 359/656

(57) ABSTRACT

In a microscope objective arrangement comprising a microscope objective (1), which may be arranged in a microscope in a working position, such that a specimen (7) arranged in the visual field of the microscope objective (1) may be detected by the microscope objective (1), a video camera (12; 22; 25; 32) coupled with the microscope objective (1) is provided, which can detect at least part of the visual field, without interposition of the microscope objective (1), when the microscope objective (1) is in its working position.

The invention relates to a microscope objective arrangement comprising a microscope objective, which may be positioned in a microscope in a working position such that a specimen arranged in a visual field of the microscope objective can be detected by said microscope. The invention further relates to the use of such a microscope objective arrangement in a microscope.

Such a microscope usually comprises several microscope objectives, which are all connected with a revolving nosepiece of the microscope allowing to bring the desired microscope objective into its working position. Since microscopic examinations require definition or control of the location to be observed on the specimen, microscope objectives have different magnification factors, so that, prior to an observation at a large magnification, a microscope objective having a smaller magnification is used to determine whether the specimen is correctly positioned. This is of particular importance in microscopic observations where the system no longer has a visual (or binocular) eye lens, as is often the case in microscopes for inspection of wafers and masks used in the manufacture of semiconductors.

Moreover, such inspection is preferably carried out using UV light (e.g. 193 nm, 157 nm), while light having a greater wavelength is used for photomacrographs. This requires beam splitting in the optical ray path following the microscope objective, which makes the optical structure of the microscope intricate and complicated.

Further, common autofocussing devices work at wavelengths of, for example, 600-800 nm, so that, also for this reason, beam splitting is effected in the optical path following the microscope objective, resulting in a complicated optical structure.

In view of the above, it is the object of the present invention to improve a microscope objective arrangement of the aforementioned type in a manner allowing simplification of the optical structure of the microscope in which the microscope objective arrangement is used.

According to the invention, the object is achieved, in a microscope objective arrangement of the aforementioned type, in that a video camera coupled with the microscope objective is provided, which can detect at least a partial area of the visual field, without interposition of the microscope objective, when the microscope objective is in its working position. Since the video camera can detect at least part of the visual field without interposition of the microscope objective, it is no longer required to provide beam splitting in the optical path following the microscope objective, so that the optical structure of the microscope, in which the microscope objective arrangement according to the invention is used, can be simplified.

Also, detection of the visual field by the video camera may be carried out at the same time as the microscopic observation through the microscope objective, allowing the microscopic examination to be carried out more quickly, because, using the video camera, a photomacrograph can be constantly filmed. For example, the photomacrograph may be evaluated, and, depending on the result of said evaluation, the distance between the sample and the microscope objective may be (automatically) adjusted such that the microscope is focussed on the specimen or is defocussed in a desired manner, and/or the specimen, depending on the result of said evaluation, may be (automatically) positioned within the visual field such that a predetermined position of the specimen is detected by the microscope objective and may, thus, be examined. This allows a quick and precise examination to be carried out. For said positioning, use may also be made of a reference image of another inspection or measurement system, said reference image then being comparable with the photomacrograph during evaluation.

For focussing and for positioning, image properties (e.g. intensity, contrast) or image information (e.g. contours) may be evaluated, for example, and said focussing and/or positioning is then effected as a function of the evaluated image properties or contours.

The microscope objective arrangement according to the invention is preferably employed in microscopes (or inspection systems) for the semiconductor industry, e.g. for inspection of wafers, masks, components or layers, or for inspection of, for example, electronic and/or optical and/or mechanical components, and in microscopes using UV light (e.g. 365, 266, 248, 213, 211, 193, 157 nm) for examination.

The video camera may be coupled with the microscope objective of the microscope objective arrangement according to the invention such that, in the working position of the microscope objective, the spatial arrangement of the video camera relative to the microscope objective is fixed or known, or is maintained, in particular, when the microscope objective is moved (e.g. along the optical axis of the microscope objective) during microscopic examination.

Such coupling is possible, for example, electrically such that the movement of the microscope objective is monitored by at least one sensor and the video camera is moved by at least one actuator in accordance with the signals from the sensor. It is also possible, of course, to couple the video camera mechanically with the microscope objective, so that the video camera is moved automatically or without taking further measures, in the same manner as the microscope objective.

In particular, the spatial arrangement of the video camera relative to the microscope objective may be selected such that the focal plane of the video camera coincides with the focal plane of the microscope. In this case, focussing of the microscope is particularly easy, since the microscope is focussed when the image of the video camera is also sharp. Also, the focal plane of the video camera may occupy a predetermined position relative to the focal plane of the microscope (for example, both focal planes may be parallel to each other and have a certain distance from each other).

In a preferred embodiment of the microscope objective arrangement according to the invention, the viewing direction of the video camera is tilted relative to the optical axis of the microscope objective. This advantageously has the effect that as large as possible a portion of the visual field of the microscope objective, preferably a larger area than the visual field, may be detected by the video camera, since it views the specimen in an oblique manner. This is very advantageous, in particular, with a view to the generally very small operative distances (in the range of a few millimeters or less) in microscopy, since the video camera is directed obliquely onto the visual field of the microscope from the side.

In the microscope objective arrangement according to the invention, the video camera preferably comprises imaging optics and a subsequently arranged image-detecting element, such as a CCD sensor. Using such a video camera, the desired area of the specimen may be easily imaged with a sufficient resolution. In particular, the use of a CCD sensor also has the advantage that the video camera may be made very small and compact, so that its weight is advantageously low.

However, other image-detecting elements, such as photodiodes, quadrant diodes, position-sensitive detectors (PSD), may also be used.

The imaging optics of the video camera may be refractive optics. However, it is also possible to use diffractive elements and/or lenses having locally varying refractive indices.

In particular, the video camera of the microscope objective arrangement according to the invention may also comprise a deflecting element allowing to mount the video camera directly on the microscope objective in such a manner that its optical axis extends parallel or substantially parallel to the optical axis of the microscope objective and that, nevertheless, an oblique viewing direction onto the visual field may be ensured. Thus, the microscope objective, including the camera attached thereto, is not substantially larger than conventional microscope objectives, so that the microscope objective arrangement according to the invention can be employed, without any problem, in already existing microscopes.

The deflecting element may be realized as a mirror (which may be planar or curved) or also as a prism, which prism may be employed to cause said deflection only by diffraction, only by reflection, or by a combination of both. In principle, gratings or diffractive elements may also be used as deflecting elements, as well as a combination of the aforementioned elements also with lenses.

A particularly preferred embodiment of the microscope objective arrangement according to the invention consists in that a separate light source is provided for the video camera. This allows optimal illumination of the specimen area detectable by the video camera and also enables, in particular, optimization of the wavelength of the radiation emitted by the light source, for example, in connection with the image-detecting element used.

Particularly preferably, the light source is mechanically coupled with the microscope objective, so that, once adjusted, the light source is always in the optimal position. This is particularly advantageous, especially in connection with the fact that the microscope objective is usually brought into its working position by rotating the revolving nosepiece, because in this case, no further measures need to be taken in order to guarantee optimal illumination.

Further, a blocking filter for the radiation of the light source may be arranged in the optical path of the microscope objective for the microscope objective arrangement according to the invention and/or in the optical path of the microscope, so as to effectively prevent an influence on or a deterioriation of the microscopic examination by the radiation of the light source.

A further advantageous embodiment of the microscope objective arrangement according to the invention consists in that the video camera is mechanically mounted on the outside of the housing of the microscope objective. This ensures that the video camera, once adjusted, is always in the optimal position. This is advantageous, in particular, if the microscope objective according to the invention is brought into the working position by moving a revolving nosepiece. Further, a conventional microscope objective is thus most easily re-fittable to become a microscope objective according to the invention, because the video camera merely needs to be attached to the housing by gluing, clamping or screwing, for example, and does not require any change in the optical system of the microscope objective.

Said mechanical fixation may be embodied such that the spatial relationship of the microscope objective and the video camera is variable and fixable.

It is further possible, in the microscope objective arrangement according to the invention, to provide a second video camera, which is coupled with the microscope objective (preferably mechanically) and which can detect at least part of the visual field, without interposition of the microscope objective, when the microscope objective is in its working position. Using the second video camera, display of an image can be advantageously ensured, if the first video camera provides poorer-quality images due to the specific geometry of the specimen, for example. Further, focussing may be easily effected by evaluating the images filmed by both cameras and adjusting the distance between the specimen and the microscope objective, as a function of the result of said evaluation, such that the microscope is focussed on the specimen or occupies a defocussed position of a predetermined magnitude (deviation).

Preferably, the parts of the visual field detected by both video cameras overlap at least partially, thus enabling a larger photomacrograph and/or better focussing.

In particular, both video cameras may have different optical magnifications, allowing to produce differently sized photomacrographs, so that the user may find a location on the specimen more quickly and more easily.

In addition to illumination by a separate light source, use may also be made of the illumination (e.g. incident light illumination, transmitted light illumination or dark field illumination) provided in the microscope, so that, advantageously, no extra light source needs to be provided.

The microscope objective arrangement according to the invention and its embodiments mentioned herein may be employed in a microscope having observation optics, wherein the microscope objective, in its working position, is arranged preceding the observation optics and transmits the radiation coming from the visual field to the observation optics. In this manner, a system for inspection or examination (microscope+microscope objective arrangement) is provided whose observation optics may be simplified, because taking a photomacrograph, positioning the specimen and/or focussing may be effected by means of the video camera (and, as the case may be, a control module to be provided in addition), in particular, in the aforementioned manner. The inspection system may comprise, for example, a display unit on which the photomacrograph is displayed. Further, the inspection system may also provide the photomacrograph for display on a separate display system which is not part of the inspection system.

In particular, the microscope objective of the microscope objective arrangement according to the invention may be attached to an objective mount of the microscope and may be brought into its working position by means of said objective mount. Thus, the use of the microscope objective arrangement according to the invention is possible especially in already existing microscopes, without having to change the latter for this purpose.

As the objective mount, a known revolving nosepiece or any other mount allowing to hold one or more objective(s) and to bring it (them) into its (their) working position(s) may be used.

However, it is also possible that not the microscope objective, but the subsequently arranged observation optics (or at least part thereof), may be exchangeable so as to realize different magnifications. This may be realized in the same manner as in microscopes (or inspection systems) for the semiconductor industry having (at least partially) exchangeable observation optics. In particular, the microscope comprising the microscope arrangement may be employed for inspection of masks and wafers, for control/inspection of components and of layers/layered systems.

In a method according to the invention for examination of a specimen by means of a microscope comprising a microscope objective, the following steps are carried out: an image of the specimen to be examined is filmed using a video camera coupled with the microscope objective, without interposition of the microscope objective; the image filmed by the video camera is evaluated; the specimen is positioned in the visual field of the microscope objective as a function of said evaluation, and, thereafter, examination is carried out.

Thus, the method according to the invention allows simultaneous and independent filming of a photomacrograph of the specimen by means of the video camera and of a photogram of the specimen or specimen portion arranged in the visual field by means of the microscope comprising the microscope objective. On the one hand, this simplifies the construction of the microscope and, on the other hand, the specimen may be positioned and examined more quickly, because there is no need to conduct mechanical switching in the microscope nor to exchange the microscope objective.

In particular, the photomacrograph and the photogram may be displayed next to each other, or also as a combined image, on a display unit (e.g. monitor) of the microscope, so that the examination will yield more information.

In the method according to the invention, positioning of the specimen may be effected in a controlled manner. Thus, after the video camera has filmed a first image, a first positioning of the specimen may be effected. Thereafter, another image of the specimen is filmed and, on the basis of this second image, it is judged (e.g. automatically) whether the specimen is positioned as desired. If this is not the case, the position of the specimen is changed again. This is effected until it has been found, by means of the image filmed by the video camera, that the specimen is positioned as desired.

In a particularly advantageous manner, the method according to the invention may be employed to examine integrated optical, mechanical and/or electronic devices or circuits as well as to examine specimens in the semiconductor industry, e.g. for inspection of wafers, masks, integrated circuits, or also in the examination of layers.

In particular, filming of the image by the video camera may be effected such that the image covers an area of the specimen (or even the entire specimen) which comprises more than the area of the specimen detected via the microscope objective. The image filmed by the video camera then represents a photomacrograph, which is very well-suited to position the specimen for the microscope (e.g. approaching a predetermined position of the specimen).

Positioning of the specimen may be effected by moving the specimen relative to the microscope (e.g. by means of a conventional microscope stage), by moving the microscope relative to the specimen or by moving both the microscope and the specimen.

In particular, in the method according to the invention, the distance between the specimen and the microscope objective may be adjusted such that the microscope is focussed on the sample, prior to effecting said examination as a function of said evaluation. In this case, it is possible, for example, to effect focussing first, so as to subsequently produce a very sharp image by taking another image of the specimen, which image allows very precise positioning of the specimen. The distance may also be adjusted such that it yields a predetermined amount of defocussing. This is advantageous, for example, in the failure analysis of defects in integrated circuits.

The microscope (comprising the microscope objective) employed in the method according to the invention as well as the video camera coupled with the microscope objective may correspond to the microscope objective arrangement according to the invention and may also be embodied according to the embodiments thereof.

A system according to the invention for examination of a specimen comprises the microscope objective arrangement according to the invention as well as a control module which may evaluate an image of the video camera and may also effect positioning of the specimen as a function of the result of evaluation. Thus, a system for examination of a specimen is provided, by which very precise examinations may be quickly performed.

The system according to the invention and, in particular, the control module may be embodied such that the steps of the above-described method according to the invention are executable.

Further, the system according to the invention may also be embodied such that the microscope objective arrangement is designed in the above-described manner.

In particular, the system according to the invention may comprise a display unit on which, for example, the image filmed by the video camera and/or the microscope image may be displayed. Also, the image data of these images may be made available to separate display systems.

The invention will be explained in more detail, by way of example, with reference to the drawings, wherein:

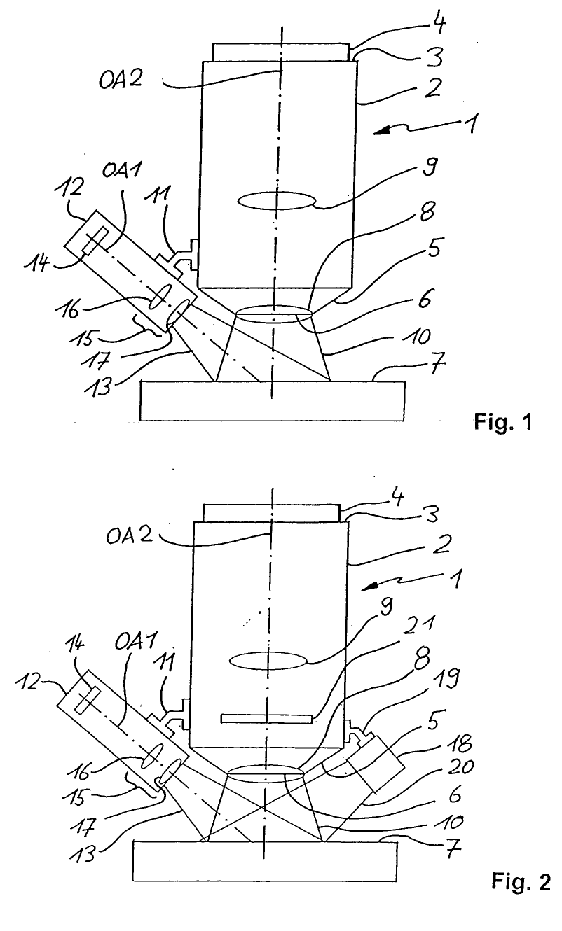

FIG. 1 shows a schematic view of a first embodiment of the microscope objective arrangement according to the invention;

FIG. 2 shows a schematic view of a further embodiment of the microscope objective arrangement shown in FIG. 1;

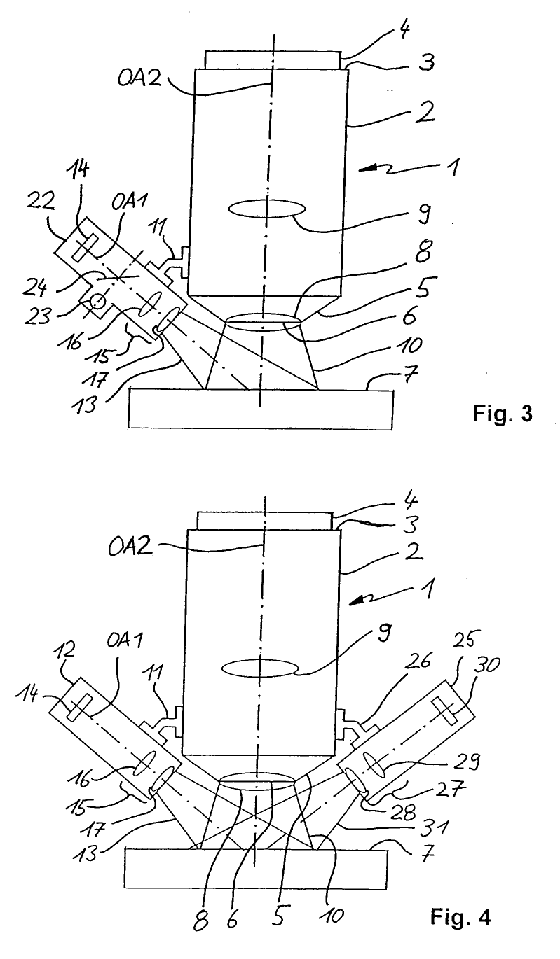

FIG. 3 shows a schematic view of a further embodiment of the microscope objective arrangement according to the invention;

FIG. 4 shows a schematic view of an embodiment of the microscope objective arrangement according to the invention comprising two video cameras, and

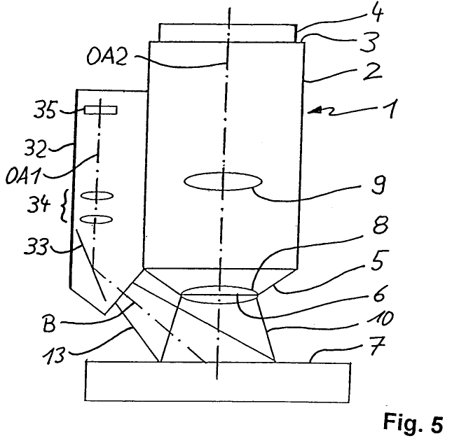

FIG. 5 shows a schematic view of an embodiment of the microscope objective arrangement according to the invention, wherein the video camera comprises a deflecting element.

The microscope objective arrangement shown in FIG. 1 comprises a microscope objective 1 having a housing 2, the top surface 3 of which is provided with a screw thread 4, by means of which the microscope objective 1 may be screwed onto a revolving nosepiece (not shown) of a microscope (not shown).

In the bottom surface 5 of the housing 2 facing away from the top surface, a light inlet opening 6 is provided through which light coming from a specimen 7 may enter the housing 2, the optical system of the microscope objective 1 being indicated by two schematically drawn lenses 8 and 9.

Using the microscope objective 1, a predetermined area of the specimen 7 may be detected, if the microscope objective 1 is in its working position as shown in FIG. 1, said area being indicated by the cone of rays 10 represented therein. This area detected by the microscope objective 1 is referred to as the visual field of the microscope objective 1.

Further, the housing 2 of the microscope objective 1 has a video camera 12 mounted thereon via a mount 11, the optical axis OA1 of said video camera 12 being inclined relative to the optical axis OA2 of the microscope objective, such that the video camera is directed obliquely onto the visual field of the microscope objective 1 from the side, as is illustrated by the cone of rays 13 shown by way of example.

The video camera 12 comprises an image-detecting element 14 which, in the present case, is a CCD element, and, arranged preceding the image-detecting element 14, imaging optics 15 schematically represented by two indicated lenses 16, 17.

An electronic evaluation system (not shown) required for the video camera 12 may be integrated into said video camera, or be connected to said housing 2 or may also be provided separately.

In the embodiment shown in FIG. 1, the video camera 12 detects the entire visual field of the microscope objective 1. However, the video camera 12 may also be embodied such that it can represent more than the visual field of the microscope objective 1 or that it only detects part of the visual field, in which case the center of the visual field should preferably be detected as well.

Using the microscope objective arrangement shown in FIG. 1, it is possible to continuously produce an image (for example, a photomacrograph) of the specimen 7 to be examined, by means of the video camera 12, so that positioning of the specimen for examination by the microscope objective 1 is easily possible. The image filmed by the video camera 12 may also be used to effect focussing, for which purpose the distance of the microscope objective 1 to the specimen 7 is changed. Changing said distance (or said working distance) is effected either by moving the microscope objective 1 along its optical axis OA2 or by moving the specimen 7 (e.g. by means of a specimen stage, not shown, on which the specimen 7 is placed) along the optical axis OA2. In both cases, this also changes the distance between the specimen 7 and the video camera 12 accordingly, due to the mechanical coupling by means of the mount 11.

In order to effect such focussing, for example, a small light spot may be produced on the specimen 7 in the visual field by means of a laser diode (not shown), which light spot is detected by the video camera 12, the position of said light spot in the detected image allowing to determine the distance of the specimen 7 from the microscope objective 1 and, thus, to adjust the desired value for focussing.

It is also possible to arrange the video camera 12 relative to the housing 2 such that a sharp image is then detected by the video camera 12, if the working distance of the microscope objective 1 is optimally adjusted and, thus, a precise examination of the specimen 7 can be carried out using the microscope objective 1 and the optical system, arranged following said microscope objective 1, of the microscope (not shown).

Particularly advantageously, the video camera 12 is provided such, according to the Scheimpflug condition, that the plane of the image-detecting element 14, the principal plane of the imaging optics and the plane of the specimen surface to be filmed intersect in one common straight line, thus allowing a completely sharp image to be obtained with the video camera 12, in spite of the oblique viewing angle of the video camera 12. This simplifies focussing and, in addition, also allows to produce a very high quality photomacrograph.

If the ambient light is not sufficient to illuminate the specimen 7 for the video camera 12, the conventional lighting of the microscope may be employed. Thus, transmitted light illumination or incident light illumination, or even dark field illumination are possible.

FIG. 2 shows a further embodiment of the microscope objective arrangement shown in FIG. 1, wherein identical elements are indicated by the same reference numerals and, for a description thereof, reference is made to the above description in connection with FIG. 1. In the microscope objective arrangement shown in FIG. 2, a light source 18 is additionally mounted on the housing 2 by means of a mount 19, said light source 18 being adapted to illuminate the entire specimen area detected by the video camera 12, as is indicated by the optical ray path 20 shown by way of example.

Further, a blocking filter 21 is arranged in the microscope objective 1, said blocking filter 21 being adapted according to the wavelength or the wavelength range of the light emitted by the light source 18 and blocking said light, so that it does not enter the optical path following the microscope objective 1. Advantageously, this effectively prevents an influence on or even a deterioration of the microscopic examination due to the illumination light for the video camera 12.

FIG. 3 shows an embodiment of the microscope objective arrangement according to the invention, wherein the video camera 22 mounted on the housing 2 already comprises an integrated light source 23, whose light may be coupled into the optical path of the video camera 22 via a semitransmitting mirror 24, so that use is made of the imaging optics 15 also as illumination optics. This advantageously ensures that the entire viewing area of the video camera 22 is illuminated. This arrangement is also extremely compact and does not require a light source to be separately provided and to be mounted on the housing 2 of the microscope objective 1.

In the embodiment of the microscope objective arrangement according to the invention shown in FIG. 4, a second video camera 25 is further mounted on the housing 2, in addition to the embodiment of FIG. 1, via a mount 26. In principle, the second video camera 25 is structured in the same manner as the first video camera 12 and comprises imaging optics 27, indicated by lenses 28 and 29 in FIG. 4, and an image-detecting element 30, which may be, for example, a CCD sensor, arranged following said imaging optics 27. The image area which can be detected by the second video camera is indicated by the cone of rays 31.

By providing the second video camera 25, focussing can be easily and quickly effected by correlating the images filmed by both video cameras 12, 25. In particular, it is also possible that the optical magnifications for both video cameras 12, 25 as determined by the imaging optics 15 and 27 are selected to be equal or different, so that, in the latter case, positioning of the specimen may be effected particularly quickly, because the user is provided with two photomacrographs having different magnifications, which make orientation on the specimen easier for him.

The second video camera 25 may be provided in accordance with the Scheimpflug condition, in the same manner as video camera 12, so that a completely sharp image may also be filmed by the second video camera 25.

An additional light source (as shown, for example, in FIG. 2) may, of course, be provided also in the embodiment shown in FIG. 4. Further, it is possible to employ the existing microscope illumination. Also, the first and/or the second video camera 12, 25 may be replaced by a video camera having its own light source, as shown in FIG. 3, for example.

FIG. 5 shows an embodiment of the microscope objective arrangement according to the invention, wherein the viewing direction B of the video camera 32 mounted on the housing 2 does not coincide with the optical axis OA1 of the video camera 32, but encloses an angle therewith, due to the provided deflecting element 33 (mirror). The video camera 32 further comprises imaging optics 34, arranged preceding the deflecting element 33, and an image-detecting element 35, which may be, for example, a CCD sensor, arranged preceding the imaging optics 34.

As is evident from FIG. 5, the optical axis OA1 of the video camera 32 may also extend parallel to the optical axis OA2 of the microscope objective 1, due to the deflecting element 33, so that, in particular, the dimension transversely of the optical axis OA2 of the microscope objective 1 can be reduced, without reducing the specimen area which can be viewed by the video camera 32.

This embodiment also allows illumination of the video camera 32 to be effected by means of the microscope illumination. Alternatively, a separate light source may also be provided, which may be either separately mounted on the housing 2 or may be provided integrally with the video camera 32.

The microscope objective arrangements described in connection with the Figures may each be used in a conventional light microscope, in particular an IR or UV light microscope, comprising observation optics. In this case, when the microscope objective of the microscope arrangement is in its working position, it is arranged preceding the observation optics and transmits radiation coming from the visual field (arriving light) to the observation optics, so that the microscope may be normally operated. The combination of the microscope objective arrangement with the microscope leads to an inspection or examination system according to the invention, wherein the observation optics, for example, may be simplified in an advantageous manner.

In particular, an image (e.g. a photomacrograph) of the specimen may be filmed by means of the video camera, and then said image is evaluated in a control module of the inspection system. Depending on said evaluation, the specimen may then be automatically positioned in the visual field of the microscope objective, as desired, and/or automatic focussing may be effected.

Alternatively, the described microscope objective arrangements may also be employed in microscopes scanning the specimen (preferably, at least in a partially serial manner). Such microscopes are, for example, a laser scanning microscope (LSM) or a confocal scanning microscope (CSM). In such microscopes, the use of the microscope objective arrangement according to the invention leads, in particular, to quicker measurement, because a photomacrograph may be filmed by the video camera in the described manner, on the basis of which positioning and/or focussing is effected. An image may be filmed by the video camera much more quickly as compared to the image filmed by the microscope by means of scanning, which results in a shorter overall time of measurement (focussing and/or positioning together with the scanning measurement).

1. A microscope objective arrangement comprising a microscope objective (1), which may be arranged in a microscope in a working position, such that a specimen (7) arranged in the visual field of the microscope objective (1) may be detected by the microscope, characterized in that a video camera (12; 22; 25; 32) coupled with the microscope objective (1) is provided, which can detect at least part of the visual field, without interposition of the microscope objective (1), when the microscope objective (1) is in its working position.

2. The microscope objective arrangement as claimed in claim 1, characterized in that the video camera is coupled with the microscope objective (1) such that the spatial arrangement of the video camera (12; 22; 25; 32) relative to the microscope objective (1) is known or fixed when the microscope objective (1) is in its working position.

3. The microscope objective arrangement as claimed in claim 1 or 2, characterized in that the spatial arrangement of the video camera (12; 22; 25; 32) relative to the microscope objective (1), when the microscope objective (1) is in its working position, is selected such that the focal plane of the video camera (12; 22; 25; 32) coincides with the focal plane of the microscope, or that the focal plane of the video camera has a predetermined position relative to the focal plane of the microscope.

4. The microscope objective arrangement as claimed in any one of claims 1 to 3, characterized in that the video camera (12; 22; 25; 32) is mechanically coupled with the microscope objective (1).

5. The microscope objective arrangement as claimed in any one of claims 1 to 4, characterized in that the viewing direction (B) of the video camera (12; 22; 25; 32) is inclined relative to the optical axis (OA2) of the microscope objective (1).

6. The microscope objective arrangement as claimed in claim 5, characterized in that the video camera (12; 22; 25; 32) comprises a deflecting element (33).

7. The microscope objective arrangement as claimed in any one of claims 1 to 6, characterized in that the video camera (12; 22; 25; 32) comprises imaging optics (15; 27; 34) and an image-detecting element (14; 30; 35) arranged following said imaging optics (15; 27; 34).

8. The microscope objective arrangement as claimed in claim 7, characterized in that a light source (18) is provided, which uses at least part of the imaging optics (15) as illumination optics.

9. The microscope objective arrangement as claimed in any one of claims 1 to 8, characterized in that a light source (18; 23), which is mechanically coupled with the microscope objective, is provided for the video camera (12; 22).

10. The microscope objective arrangement as claimed in claim 8 or 9, characterized in that a blocking filter (21) for the radiation from the light source (18) is arranged in the optical path of the microscope.

11. The microscope objective arrangement as claimed in any one of claims 1 to 10, characterized in that the microscope objective (1) comprises a housing (2), on the outside of which the video camera (12; 22; 25; 32) is mechanically mounted.

12. The microscope objective arrangement as claimed in any one of claims 1 to 11, characterized in that a second video camera (25) is coupled with the microscope objective (1), which can detect at least part of the visual field, without interposition of the microscope objective (1), when the microscope objective (1) is in its working position.

13. The microscope objective arrangement as claimed in claim 12, characterized in that the parts of the visual field which can be detected by both video cameras (12; 22; 25; 32) overlap at least partially.

14. The microscope objective arrangement as claimed in claim 12 or 13, characterized in that both video cameras (12; 22; 25; 32) have different optical magnifications.

15. Use of the microscope objective arrangement as claimed in any one of the preceding claims in a microscope having observation optics, wherein the microscope objective (1), in its working position, is arranged preceding the observation optics and couples radiation coming from the visual field into the observation optics.

16. A method of examining a specimen using a microscope comprising a microscope objective, wherein an image of the specimen to be examined is filmed using a video camera coupled with the microscope objective, without interposition of the microscope objective; the image filmed by the video camera is evaluated; the specimen is positioned in the visual field of the microscope objective as a function of said evaluation, and, thereafter, the examination is carried out.

17. The method as claimed in claim 16, wherein filming of the image by the video camera is effected such that the image includes an area of the specimen which comprises more than the specimen area detected via the microscope objective.

18. The method as claimed in claim 16 or 17, wherein the specimen is positioned such that a predetermined position of the specimen may be examined.

19. The method as claimed in any one of claims 16 to 18, wherein, prior to effecting said examination as a function of said evaluation, the distance between the specimen and the microscope objective is adjusted such that the microscope is focussed on the specimen or has a predetermined amount of defocussing.

20. A system for examination of a specimen, comprising a microscope provided with a microscope objective, a video camera coupled with said microscope objective, which video camera can film an image of a specimen arranged in the visual field of the microscope objective, without interposition of the microscope objective, as well as a control module, which evaluates an image filmed by the video camera and effects positioning of the specimen in the visual field of the microscope objective as a function of the result of evaluation.
